(19) United States
(12) Patent Application Publication
(10) Pub. No.: US 2005/0018826 A1
(43) Pub. Date: Jan. 27, 2005

(54) Conference call scheduling

(76) Inventors: David S. Benco, Winfield, IL (US); Sandra Lynn True, St. Charles, IL (US); David H. Blackmore, Mokena, IL (US)

Correspondence Address: Richard J. Minnich;Fay, Sharpe, Fagan, Minnich & McKee, LLP, Seventh Floor, 1100 Superior Avenue, Cleveland, OH, 44114, US

(21) Appl. No.: 10/624,740

(22) Filed: Jul. 21, 2003

(51) Int. Cl. H04M 3/42

(52) U.S. Cl. 379/202.01

(57) ABSTRACT

Components of a communications network automatically determine an appropriate time for a conference call. The network sends conference call invitations to desired conference participants. The invitations include proposed conference times. Responses are tallied and analyzed to determine an optimum time for the conference call. The conference call is scheduled according to the determined optimum time. Conference participants are notified of the scheduled conference time. Reminders may be sent. The network calls all conference participants at or about the scheduled conference time and interconnects successfully placed calls.

### BACKGROUND

The invention is related to the art of conference call scheduling. The invention will be described in reference to embodiments adapted for operation in mobile communications networks. However, embodiments of the invention can be directed toward other networks or combinations of networks including, for example, the public switched telephone network (PSTN).

Methods for facilitating conference calls (i.e., calls between a plurality of people using a plurality of phones or user equipment sets) are known. For example, U.S. Pat. No. 5,631,904 to Fitser, et al., incorporated herein by reference, discloses a method for establishing a conference call. In the method of Fitser, et al., a subscriber to a conference calling service predefines one or more lists of participants. Each list is associated with a different conference call or conference call group. When the subscriber wishes to initiate a conference call, the subscriber accesses the network and requests that the call be set up. The network originates (e.g., dials) calls to each of the participants in a specified list. The network then bridges these individual calls to establish the conference call.

While such methods greatly simplify the process of establishing a conference call, there are aspects of conference calling that they do not address. For example, known methods of establishing a conference call do not provide a convenient means for determining if the desired called participants are available to participate in the conference call. The conference calling subscriber or conference call organizer can only place the call and hope that the desired call participants are available. If important call participants are not available, then the time of answering call participants spent responding to their leg of the conference call and waiting for the non-responding members to join the call is wasted, and their non-conference call related activities are unnecessarily interrupted. Additionally, conference calling charges are accrued even though a productive conference call did not take place.

Alternatively, the conference call organizer may take steps to manually schedule the conference call, thereby reducing the chance that desired call participants will be unavailable when the conference call is placed. For example, the conference call organizer may place individual telephone calls to each of the desired conference call participants to determine their availability. Alternatively, the call organizer may send e-mail messages or other correspondence to each of the desired call participants to request information regarding their availability for a conference call at some point in the future. Once the conference call organizer manually determines an optimum time for the conference call, someone, most likely the conference call organizer, must manually notify the conference call participants of the scheduled conference call time and remember to manually place the conference call at the appointed time.

For the foregoing reasons, there is a desire for methods and systems for automating conference call scheduling and conference call establishment.

### SUMMARY

A method operative to facilitate the establishment of a conference call includes receiving a conference scheduling call from a conference call originator, receiving identification information regarding desired conference call participants from the conference call originator, receiving conference call parameter information from the conference call originator, sending invitations to the desired conference participants based on the identification information, the invitations including response requests, receiving responses from responding desired participants, attempting to schedule the conference call based on the received responses, notifying conference participants of the scheduled conference call time if the attempt to schedule the conference call is successful, attempting to placing calls to all the conference participants at or about the scheduled conference call time, and, interconnecting successfully completed calls.

The method can include notifying the conference originator if the attempt to schedule the conference call is not successful.

The method can also include receiving a conference editing call from the conference call originator and receiving changes to at least one of identification information regarding the participants of the conference call and conference parameter information during the conference editing call.

Some embodiments include sending reminder messages to the conference participants prior to the scheduled conference call time.

Receiving identification information regarding desired conference call participants can include receiving directory numbers regarding the desired conference participants, receiving names regarding the desired conference participants and/or receiving a group name regarding the desired conference participants.

Receiving conference call parameter information can include receiving a desired participant priority value regarding at least one desired conference call participant, receiving at least one proposed conference call time and/or receiving a purpose regarding the conference call.

Sending invitations can include sending SMS messages to user equipment of the desired participants. Alternatively, sending invitations can include sending synthesized voice announcements to user equipment of the desired participants.

Additionally, sending invitations can include sending a menu of proposed conference times, sending a request that proposed conference times be ranked according to preference and/or sending a request for an alternative conference time proposal.

Attempting to schedule the conference call based on the received responses can include searching for a proposed conference time acceptable to all of the desired conference participants, or searching for a proposed conference time acceptable to a majority of the desired conference participants.

Attempting to schedule the conference call based on the received responses can include searching for a proposed conference time acceptable to desired conference participants associated with a high priority.

Some embodiments include a method operative to facilitate the establishment of a conference call through the services of a mobile network. These embodiments can include receiving, at an MSC (Mobile Switching Center), a conference scheduling call from a conference call originator, receiving identification information regarding desired conference call participants from the conference call originator, receiving conference call parameter information from the conference call originator, sending, from the MSC, invitations to the desired conference participants based on the identification information and conference call parameter information, the invitations including response requests, receiving, at the MSC, responses from responding desired participants, attempting to schedule the conference call based on the received responses, notifying conference participants of the scheduled conference call time if the attempt to schedule the conference call is successful, notifying the conference originator if the attempt to schedule the conference call is not successful, receiving, at the MSC, a conference editing call from the conference call originator, receiving changes to at least one of identification information regarding the participants of the conference call and conference parameter information, sending, from the MSC, invitations to the desired conference participants based on the received changes, the invitations including response requests, receiving, at the MSC, new responses from new responding desired participants, re-attempting to schedule the conference call based on the new responses, notifying conference participants of the scheduled conference call time if the re-attempt to schedule the conference call is successful, attempting to placing calls from the MSC to all the conference participants at or about the scheduled conference call time, and, interconnecting successfully completed calls.

Some embodiments include sending reminder messages from the MSC to the conference participants prior to the scheduled conference call time.

Sending invitations can include sending SMS messages to user equipment of the desired participants and/or sending synthesized voice messages to user equipment of the desired participants.

A system operative to facilitate the establishment of a conference call can include a conference request interface, an invitation generator, a conference scheduler, and a conference orchestrator. For example, the conference request interface can be operative to communicate with a conference organizer to collect conference information including contact information regarding at least one desired conference participant and a set of conference parameters including at least one proposed conference time. The invitation generator can be operative to receive the conference information collected by the conference request interface and generate invitations for the at least one desired conference participant, the invitation including at least the at least one proposed conference time and requesting a response indicating at least an acceptance or rejection of at least one of the at least one proposed conference time. The conference scheduler can be operative to note the reception or lack of reception of one or more responses from the at least one desired conference participant and to determine an optimum conference time based on information included in the one or more responses and schedule the conference for the optimum time. The conference orchestrator can be operative to respond to an arrival of the scheduled conference time by orchestrating the placement of calls to conference participants and the interconnection of calls successfully placed.

Some embodiments include a conference calendar operative to communicate with the conference request interface, invitation generator, conference scheduler and conference orchestrator for purposes of storing and providing scheduling information including the conference information, information in the invitation responses, information regarding the noted reception or lack of reception of one or more responses and alert the conference orchestrator of the arrival of the scheduled conference time.

Some embodiments include a network interface operative to provide communications services to the conference request interface, invitation generator, conference scheduler and conference orchestrator for communicating with the conference organizer, at least one desired conference participant, conference participants and a network for of components for receiving, placing and interconnecting calls.

The conference request interface can be further operative to collect at least one conference participant priority value regarding at least one of the at least one desired conference participant and wherein the conference scheduler is further operative to determine an optimum conference time based on the at least one conference priority value.

The invitation generator can be further operative to generate invitations including a request for an alternate proposed conference time.

The conference request interface can be operative to communicate with the conference organizer to collect changes to the conference information.

The conference scheduler can be further operative to determine that an optimum conference time can not be determine based on information currently included in the one or more responses and to notify the conference organizer that further conference organizer input is required.

More generally, systems operative to facilitate the establishment of a conference call can include means for receiving a conference scheduling call from a conference call originator, means for receiving identification information regarding desired conference call participants from the conference call originator, means for receiving conference call parameter information from the conference call originator, means for sending invitations to the desired conference participants based on the identification information, the invitations including response requests, means for receiving responses from responding desired participants, means for attempting to schedule the conference call based on the received responses, means for notifying conference participants of the scheduled conference call time if the attempt to schedule the conference call is successful, means for attempting to placing calls to all the conference participants at or about the scheduled conference call time, and, means for interconnecting successfully completed calls.

### BRIEF DESCRIPTION OF THE DRAWINGS

The invention may take form in various components and arrangements of components, and in various procedures and arrangements of procedures. The drawings are only for purposes of illustrating preferred embodiments and are not to be construed as limiting the invention. Further, it is to be appreciated that the drawings are not to scale.

FIG. 1 is flow chart outlining a method operative to facilitate the establishment of a conference call.

FIG. 2 is a block diagram of a communications network including a system that is operative to facilitate the establishment of a conference call.

### DETAILED DESCRIPTION OF PREFERRED EMBODIMENTS

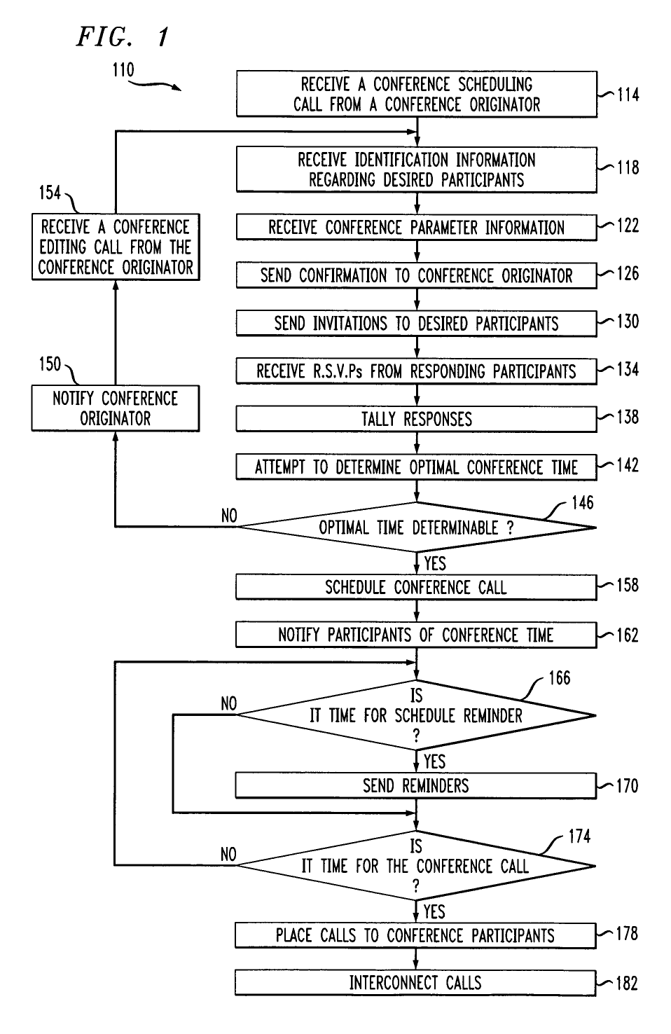

Referring to FIG. 1, a method 110 for facilitating a conference call begins with the reception 114 of a conference scheduling call from a conference originator or organizer. For example, the call is received in a switch or switching center or network adjunct adapted to facilitate conference call scheduling and establishment.

During the conference scheduling call, identification information regarding desired participants in a conference call is received 118. For example, the conference call organizer or originator provides directory numbers associated with the desired conference call participants. Additionally, the conference call organizer or originator may supply participant names or other identifying information in association with the directory numbers. Furthermore, the collection of directory numbers and/or participant names may be identified by a group name or number so that the list may be reused.

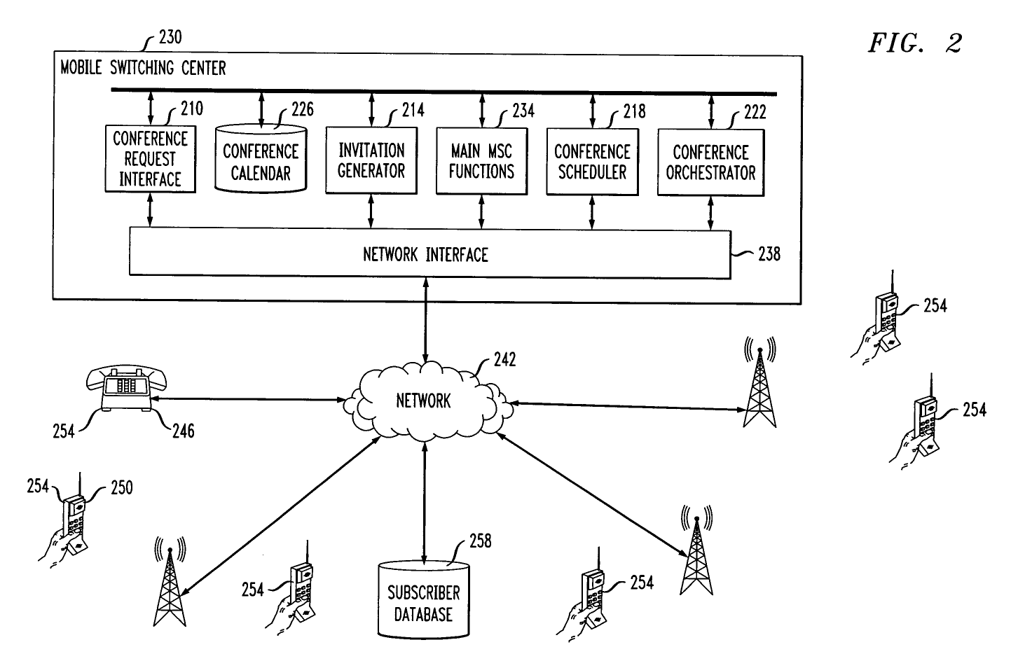

Additionally, during the conference scheduling call, conference parameter information is received 122. For instance, the conference call originator or organizer may associate a priority value with one or more of the listed desired conference participants. It may be difficult to find a conference time (date and time) for which all the desired conference participants are available. The priority value can be used to indicate to a scheduling system (e.g., see FIG. 2) those individuals whose schedules should be deferred to and those individuals for whom conference call participation is less critical. Other conference parameters that are received 122 include one or more proposed or suggested conference times.

For instance, desired participant information and conference parameter information is received through menu and voice recognition techniques, menu and key press techniques and/or other data entry procedures.

When all the identification information and conference parameters are received 118, 122 from the conference call organizer or originator, a confirmation notice may be sent 126 to the conference call originator or organizer. For instance, one or more short message service (SMS) messages are sent to a mobile phone of the conference call organizer. The messages may include the names and directory numbers of the desired participants received 118 and understood during the conference scheduling call. Additionally, the one or more messages may include the conference parameters received 122 during the conference scheduling call. Alternatively, the confirmation takes the form of a voice synthesized message and is delivered at the end of the conference scheduling call or in a separate phone call to the conference originator placed by the conference scheduling system. The confirmation message may ask the conference originator to verify the information included in the confirmation notice. Alternatively, if the information in the confirmation is not objected to within a predetermined period of time, the conference scheduling system (see FIG. 2) may assume that the information is valid. Some embodiments do not request validation or even send 126 the confirmation. Instead, it is assumed that the information received 118, 122 during the conference scheduling call is valid.

Whether actively validated or assumed to be valid, the identification information and conference parameters are used to generate invitations which are sent 130 to the desired conference participants. The conference organizer or originator may or may not be a desired participant. The invitations may take the form of short message service (SMS) messages, voice synthesized messages or other correspondence. The invitations may include a short description of the purpose of the conference and list the one or more proposed conference times (including date and time). Additionally, the invitations may include a request that the recipient select one of the proposed times or rank the proposed times in order of preference. Alternatively, the invitation may allow or request that the recipient indicate which, if any, of the proposed times are unacceptable. A simple selection may indicate that all of the proposed times are acceptable or unacceptable. Additionally, or alternatively, the invitation may include provisions that allow the recipient to offer one or more alternative proposed conference times.

Included in the invitations, either implicitly or explicitly, is a request for a response or RSVP. Where the invitations are in an SMS message format, the response may be made simply by selecting (by scrolling, pointing and/or clicking a button) one or more of the proposed conference times or by selecting an icon indicating that none of the proposed conference times are acceptable or indicating that all the proposed times are acceptable. Alternatively, an SMS format invitation may be responded to with a keypad entry indicating one or more alternative proposed conference times.

Where the invitation is in the form of a voice synthesized message indicating, for example, that “1” should be pressed if Tuesday at 2 o'clock is acceptable and/or that “2” should be pressed if Wednesday at 3 o'clock is acceptable, the response is made with one or more keypad presses. Alternatively, responses are made through voice recognition. Whatever form the invitation responses or RSVPs take, they are transmitted to the scheduling system (e.g., see FIG. 2).

When the responses or RSVPs are received 134 at the scheduling system, they are tallied 138 and/or analyzed. It is anticipated that not all the desired participants will respond to the invitations. The responses from the responding participants are tallied and/or analyzed in an attempt to find an optimum conference time (date and time). For example, the responses are compared to determine if a single time is acceptable to all the participants. Failing that, the responses may be analyzed to find a proposed conference time that is acceptable to a majority of the responding participants. Alternatively, the responses are analyzed to find a time that is acceptable to all of, or most of, the desired participants ranked with a high priority during the conference scheduling call. This analysis of the tallied 138 responses constitutes an attempt 142 to determine an optimal conference time. Subsequent to the attempt 142 to determine an optimal conference time, a determination 146 is made as to whether an optimal time is determinable based on the tallied 138 responses. If an optimal time is not determinable, the conference originator is notified 150. For example, if the proposed conference times are unacceptable to all of the desired participants that were associated with a high priority, an SMS message or voice synthesized message so indicating is transmitted to the conference originator or organizer. The notice may summarize information received in the response including, for example, alternative proposed conference times. The conference organizer may wish to edit or modify the conference parameters or the list of desired participant identification information. If so, a conference editing call is received 154, and new identification information regarding desired conference participants is received 118 and/or new conference parameters are received 122. For instance, the conference originator may want to provide new proposed conference times. For example, if some of the received 134 responses included alternative proposed conference times, the conference originator or organizer may want to accept those alternative proposals and include them in new invitations sent 130 to all the desired participants.

Of course, the list of desired conference participants or conference parameters may be edited and invitations sent 126 as many times as is necessary to receive 134 and tally 138 responses that allow the attempt 142 to determine an optimal conference time to be determined 146 to be successful. When an optimal time is successfully determined, the conference call is scheduled 158. Of course, the conference originator may be notified of the optimal time selection prior to conference call scheduling 158 in order to allow the conference originator to approve or disapprove of the determined optimal time. For example, if the determined optimal time is not one of the times proposed by the conference organizer, but is based rather on entered alternative proposed times provided by one or more of the responding participants, the conference originator may find the alternative proposed time unacceptable.

Once the conference call is scheduled, the participants are notified 162. For example, the participants are sent an SMS message or a voice synthesized call informing them of the scheduled conference time. The notification may be sent to all the desired participants or just those responding to the sent 130 invitations. For instance, if all the desired participants are notified 162, the notification may be responded to with a request to be included in the conference call. Additionally, some participants may find that their schedules now conflict with the scheduled time and may request through a response to the notification to be dropped or excluded from the conference call.

During an intervening time period between the notification 162 and the actual conference call, the system (e.g., see FIG. 2) may transmit reminder messages to the conference call participants. For instance, reminders may be sent on a schedule determined by the system (or the system designers). For instance, reminders may be sent one week, one day, one hour and 10 minutes before the scheduled conference call. Alternatively, each participant may specify a custom reminder schedule either in response to the sent 130 invitation or in response to the conference time notification 162.

In either case, determinations 166 are made as to whether it is time to send a reminder either to all the participants or to individual participants based on the preferences of the participants. When it is time to send a reminder, reminders are sent 170. For example, the system (see FIG. 2) automatically sends SMS messages or voice synthesized calls to the participants.

At the scheduled time, a determination 174 is made that it is time for the conference call, and calls are automatically placed to the conference call participants including, if desired, the conference call originator or organizer. As the calls are answered, they are interconnected 182. For example, a conference bridge is used to interconnect the calls.

Referring to FIG. 2, a system operative to facilitate the establishment of a conference call includes a conference request interface 210, an invitation generator 214, a conference scheduler 218 and a conference orchestrator 222. Additionally, the system may include a conference calendar 226. In the illustrated embodiment, the system (210, 214, 218, 222, 226) is implemented within a mobile switching center 230. The mobile switching center (MSC) 230 is a convenient location for the system (210, 214, 218, 222, 226) because main MSC functions 234 and a network interface 238 of the MSC 230 complement functions of the system (210, 214, 218, 222, 226). However, it is to be understood that the system (210, 214, 218, 222, 226) may be implemented within other network devices or as a separate network adjunct and accessed via an associated communications network 242. For example, the system (210, 214, 218, 222, 226) could be implemented within a switch of the public switch telephone network (PSTN).

The conference request interface 210 is operative to communicate with the conference organizer to collect conference information including contact information regarding at least one conference participant and conference parameters including, for example, at least one proposed conference time. For instance, the conference request interface receives 114 the conference scheduling call from the conference originator or organizer. Additionally, the conference request interface may receive 154 a conference editing call. Conference editing calls may be received 154 in response to a notification 150 that the system could not determine an optimal conference time or simply due to a required change noted by the conference originator or organizer. The conference request interface 210 receives 114, 154 the scheduling and/or editing calls through the services of the network interface 238 and the communications network 242. For instance, the conference organizer uses a piece of wired 246 or mobile 250 user equipment to place a call (scheduling or editing) to the conference request interface 210. During the call 114, 154, the conference request interface receives 118 identification information regarding desired conference participants, receives 122 conference parameter information and/or receives edits or changes thereto. The conference request interface 210 passes this information to the invitation generator 214. Alternatively, the information is stored in the conference calendar 226 where it may be retrieved as need by the invitation generator and other devices or functional blocks (e.g., 218, 222) of the system. The conference request interface 210 may also send 126 the confirmation to the conference originator or organizer.

The invitation generator 214 receives the identification information and/or the conference parameter information either directly from the conference request interface 210 or from the conference calendar 226 and uses the information to generate one or more invitations, which are then sent 130 to the desired conference participants. For example, the invitations may take the form of one or more SMS messages sent to user equipment 254 of the desired participants. Alternatively, the invitations may take the form of synthesized voice messages delivered in phone calls placed to the user equipment 254 of the desired participants. As explained above, the invitations may include a description of the proposed conference call, a menu including at least one proposed conference time (date and time). The presentation of the menu may imply a request for a response. Alternatively, the invitation may explicitly request a response. Additionally, the invitation may include menu items for indicating that all of the proposed times are acceptable and/or that all of the proposed times are unacceptable. Furthermore, the invitations may include a provision for offering one or more alternative proposed conference times. For instance, an SMS message may include an answer box for entering alternate dates and times entered via key presses or other input means associated with the user equipment 254 of the desired participants. Voice synthesized invitations may include menu selections that allow an invitation recipient to enter one or more alternative proposed conference times through voice recognition, keypad presses, or other data entry methods available on their user equipment.

It is possible that a desired user participant may receive an invitation at an inconvenient time. Therefore, the invitation generator 214 may include (in the invitation) a method for allowing the desired participant to postpone responding to the invitation. For example, the invitation generator 214 may include a telephone number and ID code within the invitations. The telephone number and ID code may allow the invitation recipient to contact the scheduling system at a more convenient time. Alternatively, the invitations generated by the invitation generator 214 may include a menu selection for requesting that the invitation generator 214 resend the invitation at a later time.

The invitation generator receives 134 invitation responses or RSVPs from responding conference call participants. The invitation generator 214 may pass these responses to the conference scheduler 218 or store the responses for access by the conference scheduler 218 at a later time. For instance, the invitation generator 214 may store the responses in the conference calendar 226 in association with the conference desired participant identification information and conference parameter information. Alternatively, conference participant, parameter and invitation response information may be stored in a subscriber database 258 associated, for example, with identification information associated with the conference originator or organizer. For instance, the subscriber database 258 is associated with a Visitor Location Register/Home Location Register (VLR/HLR) associated with the conference organizer. Where conference information is stored in the subscriber database, the invitation generator 214 communicates with the subscriber database 258 through the services of the network interface and the intervening network 242.

Where the invitations take the form of synthesized voice messages or menus, the invitation generator 214 may include a voice synthesizer. Alternatively, the voice synthesizer is associated with another component of the communications network 242. For example, voice synthesis may be included in the main MSC functions 234 of the mobile switching center 230. Alternatively, voice synthesis is a function provided by some other device associated with the network 242 and the invitation generator directs the synthesis of the voice invitation by sending controlling messages to the voice synthesis device through the network interface 238 and network 242.

The conference scheduler 218 receives 134 the conference invitation response information either from the invitation generator 214 directly or from the conference calendar 226 or subscriber database 258. Additionally, the conference scheduler 218 receives the desired participant identification information and the conference parameter information either directly from the conference request interface, the conference calendar 226 or subscriber database 258. By comparing the received 134 responses and the received desired participant identification information, the conference scheduler 218 notes the reception or lack of reception of responses from the desired conference participants. By tallying 138 and/or analyzing the received 134 responses or RSVPs, the conference scheduler 218 determines or attempts to determine an optimum conference time and schedules 158 the conference call based on that determination. If the conference schedule is unable to determine an optimum conference time, the conference scheduler 218 may notify 150 the conference originator or organizer as explained above.

When the conference call is scheduled 158, the conference scheduler 218 notifies 162 the conference participants of the conference time. For example, the conference scheduler notifies 162 the participants by sending the user equipment 254 of the participants and SMS message indicating the time (date and time) of the conference. Additionally, the SMS message may include a means for opting in or out of the conference call. For instance, if a desired conference participant indicates they are no longer available to participate in the conference, the conference scheduler may include that information in the conference calendar 226 or subscriber database or notify the conference orchestrator 222 directly. Alternatively, notification 162 is accomplished through voice synthesis.

The conference scheduler 218 may also send reminders 170 to the participants. For example, the conference schedule 218 may keep track of the scheduled conference time and compare 166 it to a current time. When a difference between the scheduled time and the current time matches certain designated reminder points, the conference scheduler 218 sends a reminder. The reminders may be in the form of SMS messages or synthesized voice calls. Alternatively, the conference calendar 226 may compare the current time to the scheduled time and notify the conference scheduler 218 when 166 it is time to transmit or send 170 a reminder. The notification 162 and reminders 170 are sent through the services of the network interface 138 and network 242.

When 174 it is time for the conference call, the conference orchestrator 222 places 178 calls to the conference participants. For example, the conference orchestrator 222 uses the received 118 identification information regarding the desired participants and information regarding invitation responses received from the conference scheduler 218, conference calendar 226 or subscriber database 258 to contact those of the desired participants that chose to, or are able to, participate in the conference call. Placing 178 the calls causes the user equipment 254 of the conference participants to alert. As each participant responds to the alert by answering the call, the conference orchestrator interconnects 182 the calls. For instance, conference orchestrator 222 accesses the main MSC functions 234 to interconnect the calls. Alternatively, the conference orchestrator 222 accesses a conference bridge (not shown) associated with the network 242 to interconnect the calls.

In some embodiments, the conference orchestrator 222 does not monitor the current time in order to determine 174 if it is time for the conference call. Instead, the conference calendar 226 makes the determination 174 that it is time for the conference call and so notifies the conference orchestrator 222.

The invention has been described with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. A method operative to facilitate the establishment of a conference call, the method comprising:
receiving a conference scheduling call from a conference call originator;
receiving identification information regarding desired conference call participants from the conference call originator;
receiving conference call parameter information from the conference call originator;
sending invitations to the desired conference participants based on the identification information, the invitations including response requests;
receiving responses from responding desired participants;
attempting to schedule the conference call based on the received responses;
notifying conference participants of the scheduled conference call time if the attempt to schedule the conference call is successful;
attempting to placing calls to all the conference participants at or about the scheduled conference call time; and,
interconnecting successfully completed calls.

2. The method of claim 1 further comprising:
notifying the conference originator if the attempt to schedule the conference call is not successful.

3. The method of claim 1 further comprising:
receiving a conference editing call from the conference call originator; and,
receiving changes to at least one of identification information regarding the participants of the conference call and conference parameter information during the conference editing call.

4. The method of claim 1 further comprising:
sending reminder messages to the conference participants prior to the scheduled conference call time.

5. The method of claim 1 wherein receiving identification information regarding desired conference call participants comprises:
receiving directory numbers regarding the desired conference participants.

6. The method of claim 1 wherein receiving identification information regarding desired conference call participants comprises:
receiving names regarding the desired conference participants.

7. The method of claim 1 wherein receiving identification information regarding desired conference call participants comprises:
receiving a group name regarding the desired conference participants.

8. The method of claim 1 wherein receiving conference call parameter information comprises:
receiving a desired participant priority value regarding at least one desired conference call participant.

9. The method of claim 1 wherein receiving conference call parameter information comprises:
receiving at least one proposed conference call time.

10. The method of claim 1 wherein receiving conference call parameter information comprises:
receiving a purpose regarding the conference call.

11. The method of claim 1 wherein sending invitations comprises:
sending SMS messages to user equipment of the desired participants.

12. The method of claim 1 wherein sending invitations comprises:
sending synthesized voice announcements to user equipment of the desired participants.

13. The method of claim 1 wherein sending invitations comprises:
sending a menu of proposed conference times.

14. The method of claim 1 wherein sending invitations comprises:
sending a request for an alternative conference time proposal.

15. The method of claim 1 wherein sending invitations comprises:
sending a request that proposed conference times be ranked according to preference.

16. The method of claim 1 wherein attempting to schedule the conference call based on the received responses comprises:
searching for a proposed conference time acceptable to all of the desired conference participants.

17. The method of claim 1 wherein attempting to schedule the conference call based on the received responses comprises:
searching for a proposed conference time acceptable to a majority of the desired conference participants.

18. The method of claim 8 wherein attempting to schedule the conference call based on the received responses comprises:
searching for a proposed conference time acceptable to desired conference participants associated with a high priority.

19. A method operative to facilitate the establishment of a conference call through the services of a mobile network, the method comprising:
receiving, at an MSC, a conference scheduling call from a conference call originator;
receiving identification information regarding desired conference call participants from the conference call originator;
receiving conference call parameter information from the conference call originator;
sending, from the MSC, invitations to the desired conference participants based on the identification information and conference call parameter information, the invitations including response requests;
receiving, at the MSC, responses from responding desired participants;
attempting to schedule the conference call based on the received responses;
notifying conference participants of the scheduled conference call time if the attempt to schedule the conference call is successful;
notifying the conference originator if the attempt to schedule the conference call is not successful;
receiving, at the MSC, a conference editing call from the conference call originator;
receiving changes to at least one of identification information regarding the participants of the conference call and conference parameter information;
sending, from the MSC, invitations to the desired conference participants based on the received changes, the invitations including response requests;
receiving, at the MSC, new responses from new responding desired participants;
re-attempting to schedule the conference call based on the new responses;
notifying conference participants of the scheduled conference call time if the re-attempt to schedule the conference call is successful;
attempting to placing calls from the MSC to all the conference participants at or about the scheduled conference call time;
interconnecting successfully completed calls.

20. The method of claim 19 further comprising:
sending reminder messages from the MSC to the conference participants prior to the scheduled conference call time.

21. The method of claim 19 wherein sending invitations comprises:
sending SMS messages to user equipment of the desired participants.

22. The method of claim 20 wherein sending reminder messages comprises:
sending synthesized voice messages to user equipment of the desired participants.

23. A system operative to facilitate the establishment of a conference call, the system comprising:
a conference request interface operative to communicate with a conference organizer to collect conference information including contact information regarding at least one desired conference participant and a set of conference parameters including at least one proposed conference time;
an invitation generator operative to receive the conference information collected by the conference request interface and generate invitations for the at least one desired conference participant, the invitation including at least the at least one proposed conference time and requesting a response indicating at least an acceptance or rejection of at least one of the at least one proposed conference time;
a conference scheduler operative to note the reception or lack of reception of one or more responses from the at least one desired conference participant and to determine an optimum conference time based on information included in the one or more responses and schedule the conference for the optimum time; and,
a conference orchestrator operative to respond to an arrival of the scheduled conference time by orchestrating the placement of calls to conference participants and the interconnection of calls successfully placed.

24. The system of claim 23 further comprising:
a conference calendar operative to communicate with the conference request interface, invitation generator, conference scheduler and conference orchestrator for purposes of storing and providing scheduling information including the conference information, information in the invitation responses, information regarding the noted reception or lack of reception of one or more responses and alert the conference orchestrator of the arrival of the scheduled conference time.

25. The system of claim 23 further comprising:
a network interface operative to provide communications services to the conference request interface, invitation generator, conference scheduler and conference orchestrator for communicating with the conference organizer, at least one desired conference participant, conference participants and a network for of components for receiving, placing and interconnecting calls.

26. The system of claim 23 wherein the conference request interface is further operative to collect at least one conference participant priority value regarding at least one of the at least one desired conference participant and wherein the conference scheduler is further operative to determine an optimum conference time based on the at least one conference priority value.

27. The system of claim 23 wherein the invitation generator is further operative to generate invitations including a request for an alternate proposed conference time.

28. The system of claim 23 wherein the conference request interface is operative to communicate with the conference organizer to collect changes to the conference information.

29. The system of claim 23 wherein the conference scheduler is further operative to determine that an optimum conference time can not be determine based on information currently included in the one or more responses and to notify the conference organizer that further conference organizer input is required.

30. A system operative to facilitate the establishment of a conference call, the system comprising:
means for receiving a conference scheduling call from a conference call originator;
means for receiving identification information regarding desired conference call participants from the conference call originator;
means for receiving conference call parameter information from the conference call originator;
means for sending invitations to the desired conference participants based on the identification information, the invitations including response requests;
means for receiving responses from responding desired participants;
means for attempting to schedule the conference call based on the received responses;
means for notifying conference participants of the scheduled conference call time if the attempt to schedule the conference call is successful;
means for attempting to placing calls to all the conference participants at or about the scheduled conference call time; and,
means for interconnecting successfully completed calls.
